(19) United States
(12) Patent Application Publication
(10) Pub. No.: US 2009/0191381 A1
(43) Pub. Date: Jul. 30, 2009

(54) Component Structure

(75) Inventors: Michael James Wallis, Clitheroe (GB); Philip Richard Kelk, Derby (GB)

Correspondence Address: OLIFF & BERRIDGE, PLC, P.O. BOX 320850, ALEXANDRIA, VA, 22320-4850, US

(73) Assignee: ROLLS -ROYCE PLC, London (GB)

(21) Appl. No.: 12/230,399

(22) Filed: Aug. 28, 2008

(30) Foreign Application Priority Data
Sep. 1, 2007 (GB) 0717009.5

(51) Int. Cl. B32B 3/00

(52) U.S. Cl. 428/156

(57) ABSTRACT

Provision of component structures with line core elements are known but enhancing beyond a certain level of stiffness for impact resistance is difficult in view of manufacturing tolerances and bond region ratios. By providing discontinuous core elements 102, 32, 42 with through bonding creating gaps 39, 49 between them, bond regions 36, 46 are created. In such circumstances enhancement of local impact or load resistance through achieving specific desired support about the bond regions 46 can be achieved whilst remaining flexible (elastic) enough to resist cracking due to high cycle fatigue. In such circumstances within a structure 101, 41 both continuous core elements 40 and discontinuous core elements 42 can be provided and formed by simple plastic deformation in a single process whilst maintaining manufacturing tolerances and acceptability with regard to bond formation.

The present invention relates to component structures and more particularly to component structures to form fan blades in gas turbine engines.

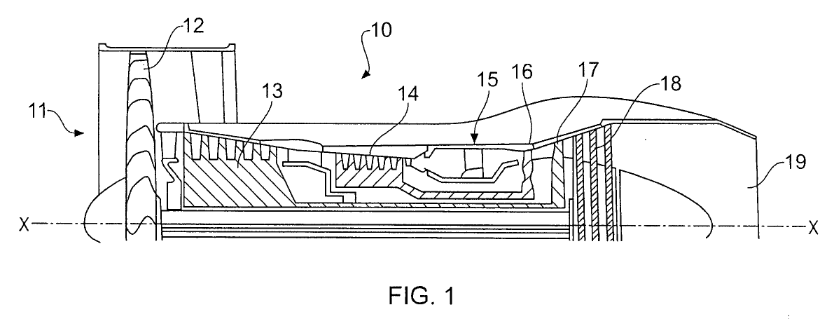

Referring to FIG. 1, a gas turbine engine is generally indicated at 10 and comprises, in axial flow series, an air intake 11, a propulsive fan 12, an intermediate pressure compressor 13, a high pressure compressor 14, combustion equipment 15, a high pressure turbine 16, an intermediate pressure turbine 17, a low pressure turbine 18 and an exhaust nozzle 19.

The gas turbine engine 10 works in a conventional manner so that air entering the intake 11 is accelerated by the fan 12 which produce two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustion equipment 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbine 16, 17 and 18 respectively drive the high and intermediate pressure compressors 14 and 13, and the fan 12 by suitable interconnecting shafts which are concentric about the axis of rotation X-X.

It will be appreciated that fan blades require a component structure which provides good mechanical strength (in order to resist impact loads) as well as meeting operational requirements (for example with regard to centrifugal and gas loading). Previously, it has been known to provide fan blades having an internal core structure comprising a number of core elements, which extend in a Warren girder type configuration between panels or sides of the component. This structure is achieved by selective application of stop off to bonding surfaces, and subsequent super plastic forming in dies to the desired component shape. The underlying core elements provide an internal support structure for the component to enable it to resist operational loads or impacts from such objects as birds, with minimal damage to the panels or membrane of the fan blade structure. The properties of the core elements are determined by the alloy used, the thickness of the membrane and the bond widths and bond spacing between the core elements in the component structure forming the fan blade. There are limitations with regard to bond spacing and resultant web angles in order to produce a core element pattern which can be manufactured and inspected to determine core geometry and quality. Traditionally the core elements are continuous elements extending across the component structure. By varying the strain of the membrane between the core elements and the bond pitch, that is to say the spacing of the core elements, it is possible to produce variations in the required impact proprieties of the component structure and therefore fan blade particularly across blade cavities. There is greater potential for variation in one dimension/direction, because the Warren girder type structure extends essentially unidirectionally within the fan blade.

With such known component structures there is a limitation to the stiffness achievable by the core elements. Buckling behaviour can only be increased for bird impact resistance by decreasing the pitch of the core elements (that is to say, reducing the space in between the core elements) or by increasing the bond width (that is to say, increasing the width of each core element). Decreasing the pitch between core elements will increase the angle of the webs, which in turn will reduce the tolerance in manufacture for alignment of panels to an underlying core element pattern. Increasing the bond width will reduce the ratio of bond length to bonded panel span, resulting in greater “quilting” during the super plastic forming process.

A further alternative is to provide core elements in the form of dots or islands distributed between the panels, but such an approach creates a structure which is too stiff in fatigue, with resultant failure at high stress levels around the core element bonds. Thus, line core elements are advantageous to avoid over stiffness in fatigue but, as indicated, can cause problems with respect to achieving increased localised stiffness, for example for impact resistance.

In accordance with the present invention there is provided a component structure, and a gas turbine engine incorporating such a structure, as set out in the claims.

Embodiments of the present invention will now be described, by way of example, and with reference to the accompanying drawings in which:—

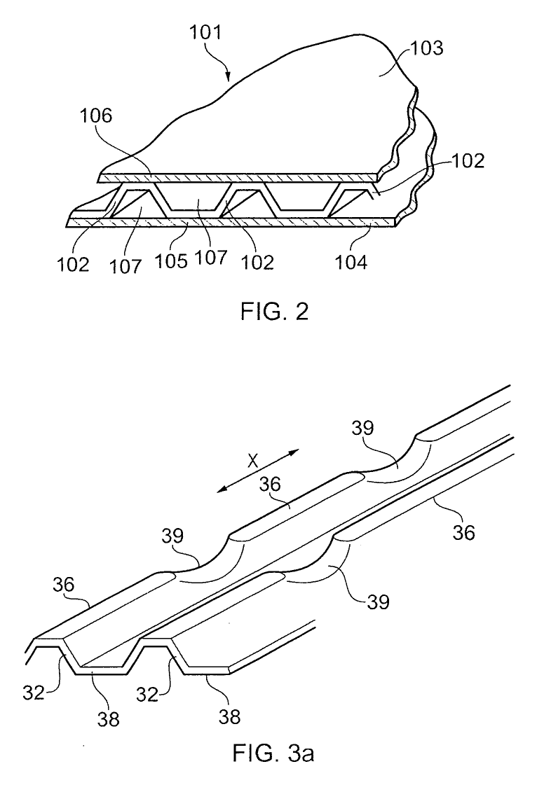

FIG. 2 is a schematic perspective view of a component structure in accordance with the present invention;

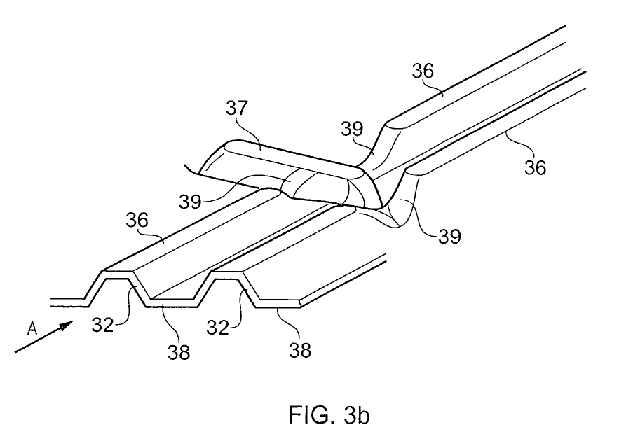

FIG. 3a is a schematic illustration of core elements utilised in the component structure as depicted in FIG. 2;

FIG. 3b is a schematic illustration of core elements utilised in the component structure as depicted in FIG. 2 where part of the bonded element is providing stiffness across the main bond element axis;

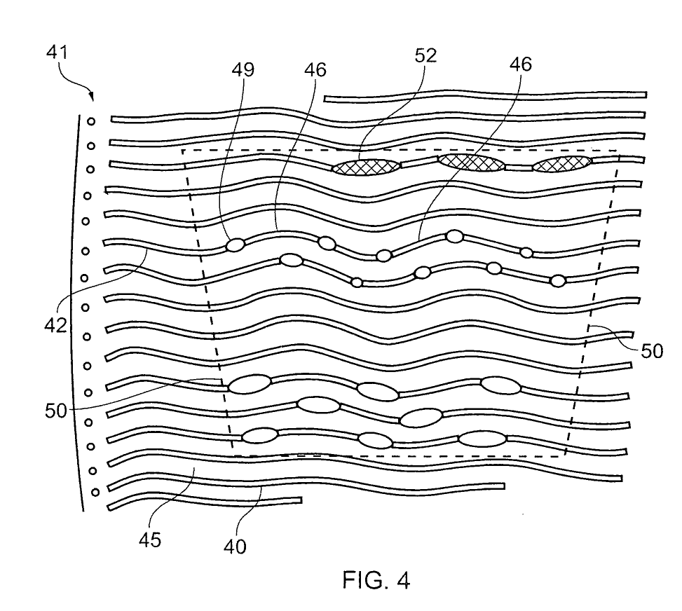

FIG. 4 is a plan view of a further alternative component structure and in particular core elements in accordance with the present invention; and

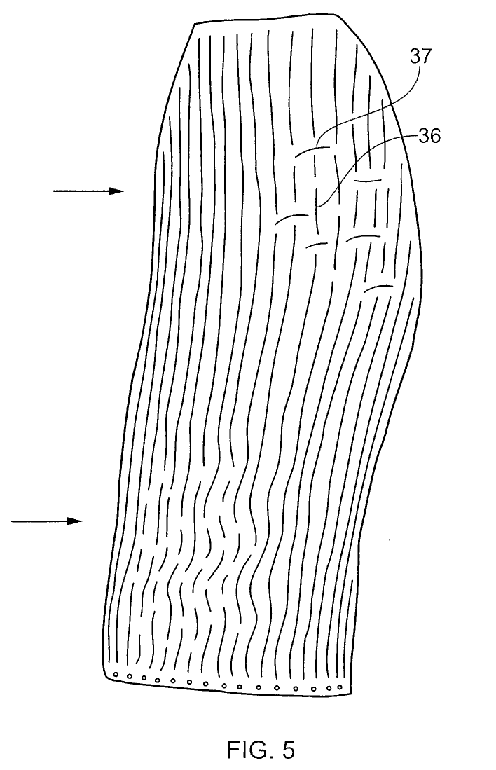

FIG. 5 is a plan view of a blade component structure showing how selective application of particular core elements might be deployed in accordance with the present invention.

In order to create lightweight but sufficiently strong and robust components such as those required for fan blades in a gas turbine engine an expanded component structure is generally required. FIG. 2 provides a schematic illustration of a component structure 101 in which core elements 102 are presented between panels 103, 104 in order to create the structure. The core elements 102 typically extend in a line beneath the panels 103, 104 such that the structure 101 is open, reducing weight, whilst the spacing and presentation of the core elements 102, 103 is specified in order to meet operational requirements such as stiffness and support. As can be seen, the elements 102 are spaced and have a pitch. Each element 102 typically takes the form of a wedge with a wider base contact with panel 104 in comparison with panel 103. Such an arrangement reduces the amount of material in the elements 102, whilst with regard to such components as fan blades, choice of which side (panel 103 or 104) will be incident to an impact load will determine the pitch and direction of the wide shape for the elements 102. As indicated above, material type and thickness as well as configuration of the core elements 102 (in terms of pitch and spacing) as well as the thickness of the panels 103, 104 will be determined with regard to structural strength. Generally, the structure will be super plastically formed to form the core elements 102 with bonding over bond widths 105, 106 defining the wedge shape for the elements 102. Strength, as indicated, can also be varied by altering the bond widths 105, 106 in use but there are limitations in terms of increasing web angles as well as bond length ratio to bonded panel 103, 104.

As will be understood, as part of the super plastic forming process, essentially the structure 101 is extended by inflation, with so-called stop-off material applied to prevent bonding before expansion between parts of the material from which the core elements 102 are formed, in order to create the voids or cavities 107, whilst bonding is provided between the core elements and the panels 103, 104.

In view of the above it is possible to decrease pitch and bond width selectively at localised areas of a component such as component structure 101.

Aspects of the present invention as depicted in FIGS. 3a & 3b provide for a discontinuous core element such that enhancement of vertical strength between the panels of a structure can be provided, and so greater stiffness under impact loads. FIGS. 3a and 3b show core elements in accordance with the present invention with panels removed. As in FIG. 2, the core elements generally comprise inline structures extending across a component structure shown schematically by arrowheads X in FIG. 3a. Thus, a panel will be bonded through bond regions 36. The width and shape of these bond regions 36 is determined in order to provide stiffness in the component structure. As can be seen, the core elements 32 are again generally provided by super plastic forming through application of stop off material to prevent bonding. The core elements 32, as indicated, comprise discontinuous structures extending in the direction of arrowheads X with intermittent gaps 39 configured and located in order to provide the desired structural strength.

It will be noted that the core elements 32 are generally configured such that the bond regions 36 are oblong or oval shaped within the core of the component structure between the panels (not shown).

As shown in FIG. 3b, some of the bond regions 37 may be at an angle to the general direction of the bond regions 36 so as to provide increased stiffness across the axis of the bond regions 36. The arrangement and density of these is determined by the directional stiffness requirement arising from the sizing event for the structure; in the case of a fan blade this is the impact of a large bird.

By provision of discontinuous core elements 36 in the direction of arrowhead X the bond area defined by the regions 36 can be adapted to suit component structure requirements. The widths of the regions 36 may be greater than will typically be acceptable within manufacturing tolerances or otherwise. Generally, in accordance with aspects of the present invention discontinuous core elements 32 will be provided only over those parts of the component structure where it is necessary to achieve a particular level of impact strength, so that the properties of different parts of the component can be tailored to their expected operational requirements, in contrast to a simple continuous line core element pattern in which the properties are essentially uniform throughout. The stiffness of a core in accordance with the present invention can be arranged to have an impact resistance which is increased without compromising manufacturing capability or inspection limitations otherwise found when changing bond pitch and width. The gaps 39 in effect provide flexibility with regard to sizing as well as providing areas of through panel stiffness, and configuration of the remaining parts of the discontinuous core elements 32. It is possible that the accumulated bonding area of the regions 32 along a discontinuous core element may be substantially the same as the bonding area of a regular bond width and pitch provided by a line core element.

It will be noted that generally the discontinuous core elements 32 would be arranged to have bond regions 36 on one side, the upper side as depicted in FIG. 3a, whilst the bottom side will have bonds in widths 38 which substantially extend in conventional line core element configuration across the width of the component structure. However, alternatively the arrangement can be the other way round with gaps 39 in the lower face or potentially discontinuous gaps provided in both the upper and lower bonding engagements between the core elements and panels (not shown) in accordance with a component structure.

Effectively, by providing gaps 39 which are only intermittent the benefits of line core configuration are provided in terms of resistance to fatigue failure. The bond regions 36 will achieve enhanced or otherwise regulated variation in support thereabout when associated with panels (not shown). The gaps 39 are generally unsupported but will be of limited width (typically of the order of the width of the bonded element 36) such that as with the pitch between core elements 32 in alignment across the component structure will not be overly detrimental to the strength of that structure.

By providing elongate oblong or oval shaped sections in the discontinuous core elements 32 as indicated, enhanced local stiffness can be provided in certain portions of a component structure such as a fan blade. Where there is relative predictability with regard to expected impact loads and sites, it is possible and is depicted in FIGS. 3a and 3b, to arrange that such impact loads in the direction of arrowhead A will occur where there is greatest support. There is full bond contact through bond widths 38 as well as where the arches of the gaps 39 contact the supported panel. The arches will tend to spread impact loads to the bond regions 36.

The discontinuities or gaps 39 created in the core elements 32 extending across the component structure are typically achieved by providing stop off material in the gaps such that during formation, through super plastic forming in dies, bonding does not occur in the regions of the gaps 39 creating the intermittent discontinuous nature of the core elements 32. Therefore, discontinuous core elements in accordance with the present invention can be formed simultaneously with the remainder of the forming process.

As indicated above, generally discontinuous core elements will only be provided over certain sections or areas of a component such as a fan blade.

FIG. 4 provides a plan view, with an upper panel removed, of a component structure 41 in accordance with the present invention. The structure 41 incorporates a number of core elements extending across it. The core elements are divided into discontinuous core elements 42 and continuous core elements 40. As described previously, the discontinuous core elements 42 incorporate gaps 49 of specified width and orientation to achieve the desired impact load resistance and other structural requirements for the structure 41. It will be noted that the core elements 42, as indicated, are intermittent, with the gaps 49 between them, but the general shape and path of the elements 42 is continuous across the component 41. It will be noted that both the continuous core elements 40 and the discontinuous core elements 42 are preferably curved.

For illustrative purposes only, it will be noted that the discontinuous core elements 42, incorporating intermittent gaps 49, are in a region defined by boundaries 50. This region 50 will typically be the region of the component which will be most likely subject to impact loads in use, such that adjustment in the bond pitch and width provided by the bond regions 46 enables enhancement of stiffness resistance in the formed component in this region 50. It will be appreciated the core element structure, provided by the core elements 40, 42 as indicated, will be secured to a panel on the rear side to the plan view depicted in FIG. 4 such that the pitch widths 51 between the core elements 40, 42 will be secured to the base panel. In such circumstances, as described above, generally spur shoulder cavities 52 will be created due to the rounding to accommodate the bonding of the upper bond regions 36 and the fuller bonding to the core elements below. These spur shoulders, as indicated previously, will create effective arching which may transfer impact loads and maintain impact robustness in use.

The specific distribution, arrangement and configuration of the respective core elements 40, 42 will depend upon operational requirements. However, generally as depicted in FIG. 4 it will be known that a certain portion of the component will be subject to the most aggressive impact loads in use.

The present invention combines the ductility of line core element patterning with localised stiffness created by enhanced core element features, and particularly by providing, preferably, an oblong or oval shape to the bond regions. By creating these localised effects, selective areas of a component such as a fan blade can be produced with the intermittent discontinuous core element to provide enhanced overall strength under impact conditions whilst retaining full line core configuration in the remainder of the component structure. Although described particularly with regard to a fan blade for a gas turbine engine, it will be appreciated that other core structures can be formed, in accordance with the present invention, where provision of a discontinuous intermittent core element pattern will be useful in order to alter structural strength and performance in localised regions of that structure. It will be understood that utilisation of super plastic forming, in association with diffusion bonding, will enable provision of component structures in accordance with aspects of the present invention, which will normally combine discontinuous intermittent core elements with continuous core elements which may be conventional substantially straight line core elements, or wavy dependent upon requirements. It will be understood that by utilisation of aspects of the present invention components may be defined which preferentially deform under impact loads. For preferential deformation it will be appreciated, by creating areas of different stiffness, impacts upon that component may be deflected to areas of lower stiffness and therefore preferential deformation achieved possibly deflecting impact loads away from sensitive underlying regions.

FIG. 4 illustrates provision of one region 50 within a component structure 41 having enhanced stiffness in accordance with aspects of the present invention. It will also be appreciated that several areas of different impact resistance or other structural change may be provided within the same structure by providing several regions 50.

As will be noted in FIG. 4, the width and distribution of the gaps 49 is generally different in each core element. This distribution of gaps 49, and therefore sizing and shaping of the bond regions 46, will be determined by appropriate analysis in order to achieve the desired definition in specific distinct support within the component structure 41.

FIG. 5 provides a plan view of a complete blade component, illustrating that the features of this invention are not necessarily required over the whole of the area and specific features and arrangements as described are provided where required to provide stiffness in the critical loading directions. For other items and operating conditions, this pattern of features will vary accordingly. FIG. 5 also shows the provision of bond regions 37 at an angle to the bond regions 36, as described above with regard to FIG. 3b. In this embodiment, the regions 37 are substantially perpendicular to the regions 36, but it will be appreciated that they may be arranged at a different angle.

Generally, components in accordance with aspects of the present invention will be formed of metals utilising super plastic deformation techniques. However, plastic materials may be used and formed if required.

1. A component structure comprising first core elements extending across the structure with bond regions providing discontinuous through thickness bonding to provide a region of increased stiffness in more than one axis or plane.

2. A structure as claimed in claim 1 where the first core elements generally form a Warren girder style arrangement.

3. A structure as claimed in claim 1 and comprising second core elements extending across the structure at an angle to the first core elements to provide stiffness at an angle to of the first core elements.

4. A structure as claimed in claim 1 wherein the through thickness bonds are irregularly spaced.

5. A structure as claimed in claim 1 wherein the spacing of the outer panels is not uniform.

6. A structure as claimed in claim 1 wherein the component structure is a fan blade for a gas turbine engine.

7. A structure as claimed in claim 1 wherein the discontinuous through thickness bonding is provided in those regions of the component where the most severe loads are expected in use.

8. A structure as claimed in claim 1 wherein the second core elements are provided in those regions of the component where the most severe loads are expected in use.

9. A structure as claimed in claim 1 wherein the bond regions are generally oblong or oval shaped.

10. A structure as claimed in claim 1 wherein the first core elements are in a line or path across the structure.

11. A structure as claimed in claim 10 wherein the line or path incorporates waves or undulations.

12. A gas turbine engine incorporating a component structure as claimed in claim 1.
